(19) United States
(12) Patent Application Publication
(10) Pub. No.: US 2024/0212087 A1
(43) Pub. Date: Jun. 27, 2024

(54) COMPUTER GENERATED DYNAMIC SHOPPING EXPERIENCE BASED ON DELIVERY DATA

(71) Applicant: INTERNATIONAL BUSINESS MACHINES CORPORATION, Armonk, NY (US)

(72) Inventors: Christian Compton, Austin, TX (US); Martin G. Keen, Cary, NC (US); Jeremy R. Fox, Georgetown, TX (US); Sarbajit K. Rakshit, Kolkata (IN)

(21) Appl. No.: 18/146,640

(22) Filed: Dec. 27, 2022

(51) Int. Cl. G06Q 50/30; G06F 18/22; G06Q 10/083; G06Q 10/0833; G06Q 10/087; G06Q 30/0601

(52) U.S. Cl. CPC G06Q 50/30; G06F 18/22; G06Q 10/0833; G06Q 10/0838; G06Q 10/087; G06Q 30/0635

(57) ABSTRACT

Dynamic shopping that includes receiving, at a system, an order for a selected product for purchasing and a package pickup location from a device of a user. The method can further include determining a type of product the user has ordered for pick up at the package pickup location, and the method can use the system for dynamic shopping to determine other products for potential order at the pickup location. The computer implemented method can also add to the order other products for potential order.

### BACKGROUND

The present invention generally relates to computer based enhancement of product delivery to a user, and more particularly to providing, using a computer system, further shopping opportunities at the destination of a product that is being delivered.

A pickup point allows the customer to choose where he/she wants to receive their order. A user is generally informed of the availability of the package in the pickup point, at which point they will have to collect it. Out-of-home delivery has the advantage of being more flexible than home delivery. It offers to the customer or user the possibility of choosing a delivery location or a pickup point according to a user's location or schedule, and can include a drop off location for a package. For example, a pickup point may be nearest to a users or customer's home or office, and selection of pickup points can also be based on the hours a pickup point is open.

### SUMMARY

In accordance with some embodiments of the present disclosure, computer implemented methods, systems and computer program products have been provided for dynamic shopping based upon pickup location.

In one aspect, a computer implemented method is described for dynamic shopping that includes receiving, at a system for dynamic shopping, an order for a selected product and a package pickup location from a device of a user; and determining at the system for dynamic shopping a type of product the user has ordered. The computer implemented method can further include determining with a product matching engine of the system for dynamic shopping other products for potential order by the user at the pickup location. In some embodiments, the product matching engine employs a neural network trained with a historical database of orders to match the type of the product the user has ordered to categories of products to select the other products for potential order by the user. The method may further include initiating using the system of dynamic shopping, inclusion and transport of the other products with the selected product for delivery to the package pickup location.

In another aspect, a system is described for dynamic shopping that includes a hardware processor; and a memory that stores a computer program product, the computer program product when executed by the hardware processor, causes the hardware processor to receive an order for a selected product and a package pickup location from a device of a user; determine a type of product the user has ordered; and determine with a product matching engine products for potential order by the user at the pickup location. The product matching engine employs a neural network trained with a historical database of orders to match the type of the product the user has ordered to categories of products to select the other products for potential order by the user. In some embodiments, the system can also initiate inclusion and transport of the other products with the selected product for delivery to the package pickup location.

In yet another aspect, a computer program product is described for dynamic shopping. The computer program product can include a computer readable storage medium having computer readable program code embodied therewith. The program instructions executable by a processor to cause the processor to receive an order for a selected product and a package pickup location from a device of a user. The computer program product can also determine, using the processor, a type of product the user has ordered; and determine, using the processor and a product matching engine, other products for potential order by the user at the pickup location. The product matching engine employs a neural network trained with a historical database of orders to match the type of the product the user has ordered to categories of products to select the other products for potential order by the user. The computer program product can also initiate, using the processor, inclusion and transport of the other products with the selected product for delivery to the package pickup location.

### BRIEF DESCRIPTION OF THE DRAWINGS

The following description will provide details of preferred embodiments with reference to the following figures wherein:

FIG. 1 is an illustration of an example environment in which the computer implemented methods, systems and computer program products have been provided for dynamic shopping based upon pickup location, in accordance with one embodiment of the present disclosure.

FIG. 2 is a flow diagram showing a method for dynamic shopping based upon pickup location, in accordance with one embodiment of the present disclosure.

FIG. 3 is a flow/block diagram depicting a first embodiment of a system dynamic shopping based upon pickup location, in accordance with one embodiment of the present disclosure.

FIG. 4 is a generalized diagram of a neural network, in accordance with one embodiment of the present disclosure.

FIG. 5 is a block diagram illustrating a system that can incorporate the system for dynamic shopping based upon pickup location of a product that is depicted in FIG. 2, in accordance with one embodiment of the present disclosure.

FIG. 6 depicts a computing environment according to an embodiment of the present disclosure.

### DETAILED DESCRIPTION

The methods, systems, and computer program products described herein can provide for dynamic shopping creation based on the selection of commerce based pick up points. A “pickup point” allows a customer to choose where he/she wants to receive their order. The customer is informed of the availability of the package at the pickup point and will only have to collect it, e.g., personally, or by using an agent, such as an autonomous vehicle. In accordance with some implementations of the methods, systems and computer program products of the described dynamic shopping environment, if the customer (also referred to as user) picks up the ordered products from a location at a scheduled time, then the customer just picks up the product as expected. However, in accordance with the described, computer implemented methods, systems and computer program products for dynamic shopping that are described herein, the user can also send autonomous vehicles (AV) to retrieve the product from the pickup points upon delivery. In has been determined that when the user (or in the case of an autonomous vehicle (AV) acting as an agent of the user) is at the pick up point, the seller (also referred to as a merchant) is missing an opportunity to display additional products. The computer implemented methods, systems and computer program products that are described herein provide a dynamic market place of products that they can also purchase at the pickup point, in addition to the products of their original order. This will enable the user to look at the additional products and can also buy along with the already pick up products.

As will be described herein, the computer implemented methods, systems and computer program products that are described herein can allow a customer to order using an online order through the internet, and accordingly the delivery system will deliver the product to the customer location. In the computer implemented methods, systems and computer program products of the present disclosure, the customer can specify an order of pickup points, and the disclosed dynamic system can identify additional products that the user may be interested in purchasing from a temporary shopping facility that is set up at the pickup point. The inventory of the temporary shopping facility can be selected based on the type of product in the initial order, the customer profile and the pickup location of the original order.

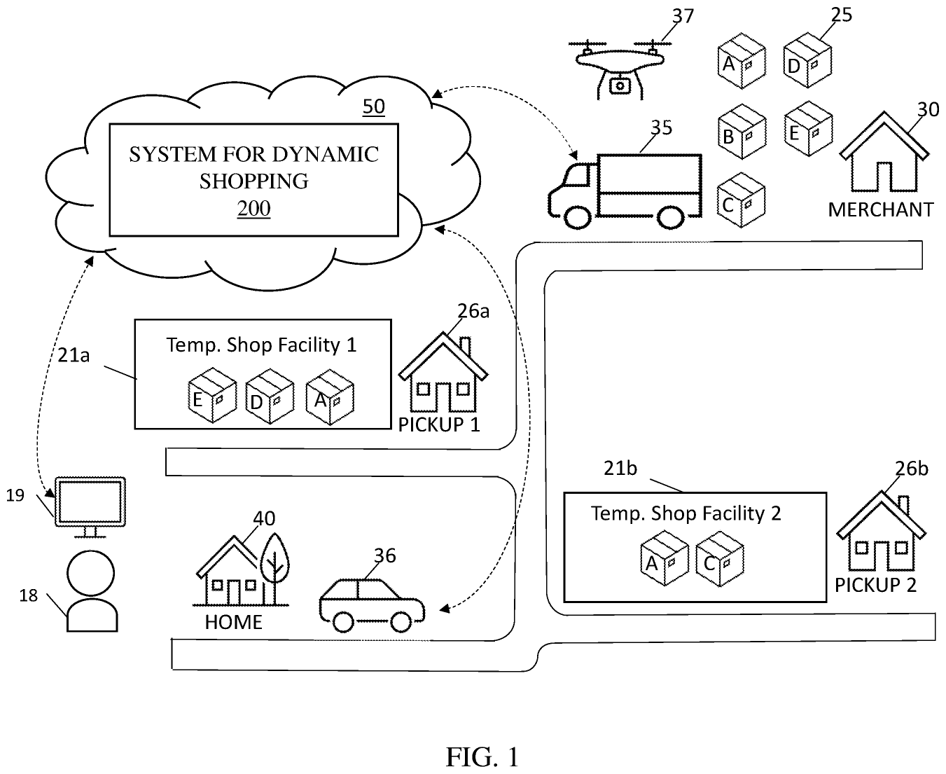

The methods and systems of the present disclosure are now described in greater detail with reference to FIGS. 1-6.

FIG. 1 in illustrations of an example environments to which the methods, systems and computer program products for providing intelligent dynamic shopping may be applicable. In the environment depicted in FIG. 1, a distributed computing system 50 is applied to a delivery of goods application, e.g., the goods identified by products having reference letters 25A, 25B, 25C, 25D, 25E, that includes an intelligent dynamic shopping environment from which the user 18 can select additional products for purchase at the pickup points, e.g., pickup points 1 and 2, of their original purchase. In the examples described herein, the original product may be represented by reference number 25A. In the example depicted in FIG. 1, the other products that are identified by the product matching engine of the dynamic shopping engine that are arranged in temporary shopping facilities at the different pickup points are represented by reference numbers 25C, 25D, and 25E. The dynamic shopping system 200 provides the merchant 30 of the goods with an additional opportunity to make additional sales to the user 18 at the time of delivery of the user's original purchase order.

FIG. 1 is an illustration of an example environment in which a consumer 18 (also referred to as user) is purchasing products 25A, 25B, 25C, 25D, 25E from a merchant 30 at their location, e.g., distribution warehouse, to which the methods, systems and computer program products for intelligent dynamic shopping during delivery of a product being delivered is applied. As illustrated in FIG. 1, the consumer 18 may make an online order, e.g., through the internet, by which the system 200 may be applied. More particularly, the system for dynamic shopping based upon pickup location 200 may be a component of a distributed computing system. A distributed system is a computing environment in which various components are spread across multiple computers (or other computing devices) on a network. These devices split up the work, coordinating their efforts to complete the job more efficiently than if a single device had been responsible for the task. In some embodiments, the system for dynamic shopping based upon pickup location 200 is cloud based 50. A cloud based system, often known as cloud computing, is a broad term for anything that involves the delivery of hosted services via the internet. As illustrated, the consumer 18 may interact with the system for dynamic shopping based upon pickup location 200 via a terminal, e.g., consumer or user device 19, that is in communication to the product delivery system, e.g., wirelessly, such as through the internet.

Additionally, the cloud based system for dynamic shopping based upon pickup location 200 may also be in communication with the merchant 30, as well as deliver vehicles 35 for the merchant 30. In some embodiments, the delivery vehicles 35 may be an autonomous car. A self-driving car, also known as an “autonomous car”, driver-less car, or robotic car, is a car incorporating vehicular automation, that is, a ground vehicle that is capable of sensing its environment and moving safely with little or no human input. It is noted that the delivery vehicles 35 are not limited to ground based vehicles, such as cars and trucks. In some embodiments, the delivery vehicle may also be an air based drone 37, which can be either human operator controlled, or may also be an autonomous type vehicle 35. Essentially, a drone is a flying robot that can be remotely controlled or fly autonomously using software-controlled flight plans in its embedded systems, that work in conjunction with onboard sensors and a global positioning system (GPS).

The delivery vehicles 35 (and drones 37) for the merchant 30 may include global position system (GPS) tracking that helps to provide their location to the system for dynamic shopping based upon pickup location 200.

The system for dynamic shopping based upon pickup location 200 can provide at least the following aspects: pickup point creation opportunities, additional product display optimization for sales potential, offsite notification for autonomous vehicle pickup vs. manual human pickup, drone swarm utilization, historic knowledge corpus of pickup points, and comparing relative location and distance of pickup points.

Pickup point creation opportunities are based on identified non-shopping store common pickup points of various customers 18. The system for dynamic shopping based upon pickup location 200 can profile the customers 18, and can dynamically create a subset of the shopping stores around the pickup point, e.g., pickup point 1 and pickup point 2, so that customer 18 can buy additional items at the pickup points from the temporary created shopping facilities.

The additional product display optimization for sales potential includes the system for dynamic shopping based upon pickup location 200 arranging predicted products with appropriate placing of the products around the pick-up points so that while picking up products, the customer 18 can also buy additional products from the temporary created shopping facilities 21a, 21b around the pickup points, e.g., pickup point 1 and 2.

The system for dynamic shopping based upon pickup location 200 can also provide offsite notification for autonomous vehicle pickup vs. manual human pickup. More particularly, in some embodiments, the system 200 can identify if customer 18 is arrived to pickup the products or autonomous vehicle is arrived to pickup the product, and accordingly if autonomous vehicle is arrived, then system will be notifying customer about the availability of additional product around the pickup point, so that customer can buy and autonomous vehicle can pickup the same.

The system for dynamic shopping based upon pickup location 200 can also employ drones 37, e.g., drone swarm utilization. For example, in addition to the autonomous vehicles 35 that can deliver the ordered products, as well as additional products for the temporarily created shopping facilities 21a, 21b, the system for dynamic shopping based upon pickup location 200 can use a swarm drone mechanism and can temporarily offer items for the temporarily created shopping facilities 21a, 21b around the pickup point, e.g., pickup point 1 26a and pickup point 2 26b, so that the customer (user 18) can pick up the ordered product in person and/or using an autonomous vehicle 36 as an agent, and can also buy products additionally from the temporary shopping facility 21a, 21b.

The system for dynamic shopping based upon pickup location 200 also maintains a historical knowledge corpus of pickup points. For example, the system can historically be identifying different pickup point, e.g., pickup point 1 and pickup point 2, selected by customers 18, and accordingly the proposed system will proactively be arranging temporary items around the pickup points, e.g., pickup points 1 and 2, so that time and resource required for temporary shopping store creation can be minimized.

The system for dynamic shopping based upon pickup location 200 can also compare relative location and distance of pickup points. For example, the system 200 will be identifying the relative distance and location of different pickup points around the smart city, and accordingly be arranging the additional products around the pickup points so that aggregated cost of creating the temporary shopping store can be minimized.

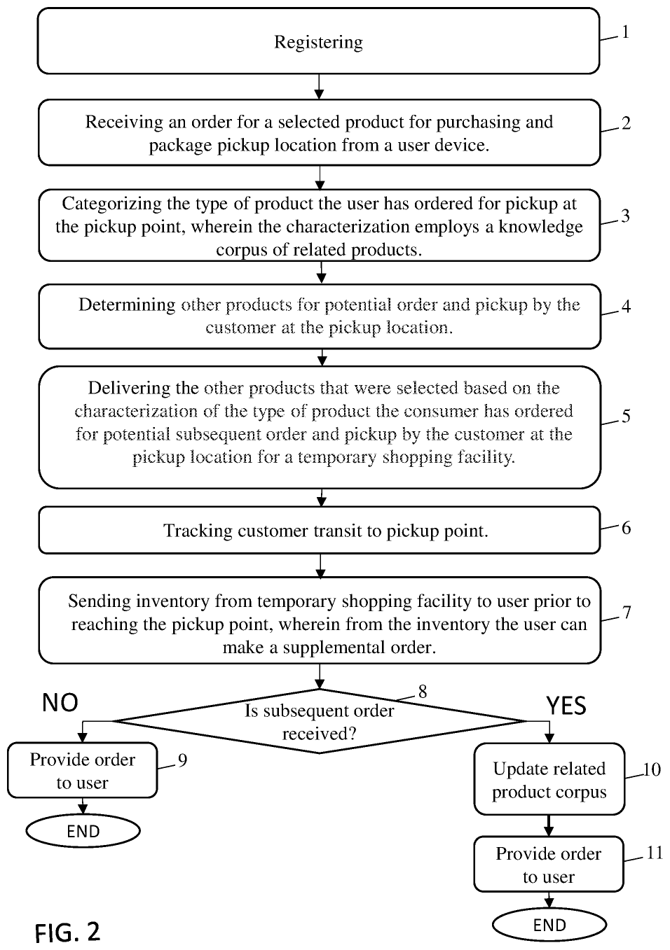

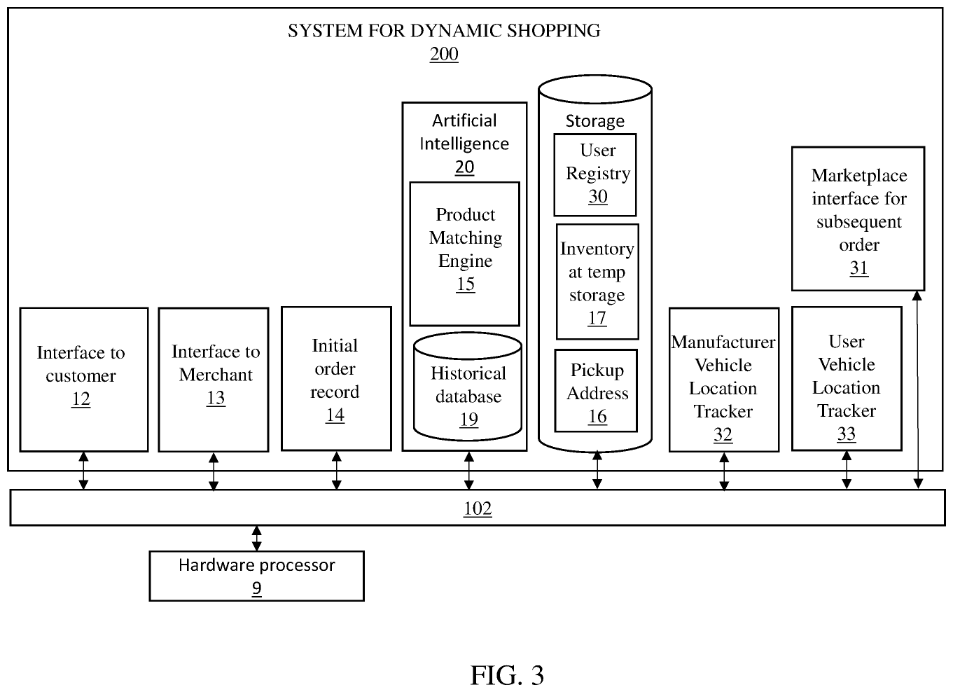

FIG. 2 is a flow diagram showing a method for providing dynamic shopping based upon pickup location. FIG. 3 is a flow/block diagram depicting an embodiment of a system 200 for providing dynamic shopping based upon pickup location.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The method for providing dynamic shopping based upon pickup location that is illustrated in FIG. 2 may begin at block 1, which can include registering users 18 (also referred to as customers) with the system for dynamic shopping 200. Referring to FIG. 3, the system 200 may include an interface to customer 12, as well as an interface to the merchant 13. Through these interfaces the system 200 may receive permission from the customer 18 and/or the merchant 30 for the purposes of data collection. As illustrated the user 18 may employ a user device identified by reference number 19, which may be a terminal, such as a desktop computer, mobile computer, laptop tablet computer, smart phone, etc., to communicate with the system 200 through the user to the customer 12.

The method may begin with in response to receiving permission from a user 18 for data collection, and registering users 10 with the system for contextual wearable device recommendations 100. To the extent implementations of the invention collect, store, or employ personal information provided by, or obtained from, individuals (for example, current locations of drivers, historical records of drivers, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

In some embodiments, by registering with the system 200, a consumer profile is established. The consumer profile may be stored in the user registry 34. The consumer profile is a record of previous consumer orders and pickup points. This information can be used in combination with artificial intelligence analysis, as well as a pool of information on other consumer purchases and pickup points, to determine additional product to be offered to a user through a temporary shopping facility.

In one embodiment, the computer implemented method for dynamic shopping based upon pickup location may include receiving an order for a selected product 25A for purchasing and package pickup location from a user device at block 2. In some embodiments, a customer 18 orders products from merchant 30, in which a pickup address 26a, 26b is provided at block 2 of the flow chart illustrated in FIG. 2. In some implementations, the customer 18 may also provide their home address 40. However, in some instances, when the customer 18 has registered with the system at block 1, the system 200 can have the user 18 address at the time the order is made.

The order is made by the user 18 using a user device 19, e.g., desktop computer, mobile computer, laptop, tablet, smartphone, smartwatch, etc, from which the user 18 can access on online marketplace from which the user 18 can order the initial goods, e.g., the initial product 25A. The user 18 order at the online marketplace can interface to the system 200 through the user interface 12 and/or the merchant interface 13. Once received by the system for dynamic shopping 200, the initial order is recorded in the initial order record 14 of the system depicted in FIG. 3. In the embodiment that is illustrated in FIG. 1, the initial product may be identified by reference number 25A. In the illustrated example, the initial product 25A is made available for pickup by the customer 18 and/or customer's agent (which may be an autonomous vehicle 36) at a pickup point, e.g., pickup point 1 25a and/or pickup point 2 25b.

In some embodiments, upon receipt of the original order, the shopping system 200 has an option to select pickup points, e.g., pickup point 1 26a and pickup point 2 26b, and to improve the flexibility, the system 200 can provide additional non-shopping store location as pickup point. The proposed system identifies if the customer 18 has specified a pickup location which is not a shopping location.

The system 200 includes storage with data corresponding to the pickup point addresses 16 that were selected by all users 9 that were registered with the system 100. In this instance, when the user 18 enters a product pickup location, the system can determine other pickup locations that are within the same range. In some instances, these pickup locations may already have both the initial product for the original order in stock, as well as additional products, which may be of similar type, or have been of interest to other consumers when ordering the original product. This information can reduce the resource usage of the system 200.

The system for dynamic shopping 200 can identify which products 25A the customer 18 has selected and option of pickup of product, e.g., select the pickup point 26a, 26b. The customer 18 can specify the pickup location and the same will be defined by the customer 18 while shopping.

The shopping system 200 can identify different pickup locations 26a, 26b of the products by different customers. The proposed system 200 will be aggregating different pickup points around the smart city.

For example, the system 200 for dynamic shopping 200 that is depicted in FIG. 3 can include storage, e.g., hardware memory, including at least one module of memory for storing pickup addresses 16. From the original pickup address provided in the original order, the system 200 can find additional suitable pickup points. In some embodiments, this can be based on proximity of the pickup points to the originally selected pickup point for the original product ordered. In other instances, difficult pickup points may be designated based on existing product inventory at a temporary shopping facility 21a, 21b that has been set up at a pickup point. The temporary shopping facility may have goods in inventory meeting the order of the user 18. The knowledge corpus of related products may be provided by the historical database 21 of the system for dynamic shopping 200.

Based on the identified pickup points, the proposed system will be identifying what types of products are to be picked up, e.g., additional products to be added in addition to the product of the original order. The system 200 can use an historical database 21 in combination with a product matching engine 15 and artificial intelligence 20 to make this type of determination.

Referring to FIG. 2, the computer implemented method may continue to block 3. Block 3 includes categorizing the type of product 25A the user 18 has ordered for pickup at the pickup point, wherein the characterization employs a knowledge corpus of related products. In some embodiments, the items, e.g., product 25A, in the order are classified to derive the types of items being picked up and the relevancy of additional products to present. For example, the additional products may be identified by reference numbers 25B, 25C, 25D, 25E, as illustrated in FIG. 1. The shopping system 200 can identify different pickup point locations.

In some embodiments, the system for dynamic shopping 200 can identify the different types of customers 18, and the types of customers can be identified based on the types of products selected. For example, the system 200 that is depicted in FIG. 3 can include storage, e.g., memory, that includes pickup addresses 16. In some embodiments, the system 200 when provided a pickup address for an initial order, can review additional pickup addresses that are close to the selected pickup address, and in some instances when a temporary shopping facility has already been established for an alternative pickup address, the alternate pickup address and the associated temporary shop facility information can be provided to the user.

In one example, the product of the initial order may be characterized as being a food stuff, such as a snack. In another example, the product of the initial order may be characterized as being an automotive product, such as an automotive replacement part. In yet another example, the product of the initial order may be characterized as being a pharmaceutical product. In yet an even further example, the product of the initial order may be characterized as being a clothing, such as outdoor clothing. In yet another embodiment, the initial order may be characterized as a technology type order, such as computing or consumer electronics. In an even further embodiment, the initial order may be characterized as medical equipment. It is noted that the above examples of categories are provided for illustrative purposes only, and are not intended to limit the present disclosure.

Referring to the computer implemented method illustrated in FIG. 2, the method can progress to determining other products for potential order and pickup by the customer at the pickup location at block 4. The system 200 can predict what types of additional products, e.g., identified by 25C, 25D, 25E, can be arranged around the pickup products, i.e., the product of the original order, based upon the customer profile and order classification. In some embodiments, the system 200 can predicting if the temporary creation of shopping store, by having similar items physically present at the pickup site, will be encouraging the customer to buy additional products. The system can identify what products can be placed around the pickup packages.

The system 200 includes a product matching engine 15. The product matching engine may include one or more algorithms for determining other products for potential order and pickup by the customer at the pickup locations at block 4. As noted above, the system 200 can determine not only match products but also whether matching products have already been placed in a temporary shopping facility at a pickup location that may not be the exact pickup location selected by the user, but is still proximate to the selected pickup location. For example, the user may have selected product 25A for delivery at a first pickup location 26a. However, the second pickup location 26b may have a temporary shopping facility 21b that includes the product of the original order, e.g., product 25A, as well as an additional product, e.g., product 25C, that has been identified by the product matching engine 15 as being of potential interest to the user 18. In this scenario, the user 18 may be informed of the temporary shopping facility 21b at the second pickup location 26b.

The product matching engine 15 may include at least one module of memory including instructions for matching products having a same category as the product of the initial order for placement at the pickup points 26a, 26b, and at least one hardware processor 22 for performing the instructions in providing the matching step described in block 4 of FIG. 2.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

The product matching engine 15 may be provided by some form of artificial intelligence 20 providing device to determine matches. In some embodiments, the product matching engine 15 may include neural networks, expert systems, genetic algorithms, intelligent agents, logic programming, and fuzzy logic. Neural network artificial intelligence is based loosely upon the cellular structure of the human brain. Cells, or storage locations, and connections between the locations are established in the computer. As in the human brain, connections among the cells are strengthened or weakened based upon their ability to yield “productive” results. The system uses an algorithm to “learn” from experience. Neural nets are an inductive reasoning method. Expert systems are usually built using large sets of “rules.” Genetic algorithms utilize fitness functions, which are relationships among criteria, to grade matches.

In one example, the product matching engine 15 is an artificial neural network providing device. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained in-use, with learning that involves adjustments to weights that exist between the neurons. An ANN is configured for a specific application, such as pattern recognition or data classification, through such a learning process.

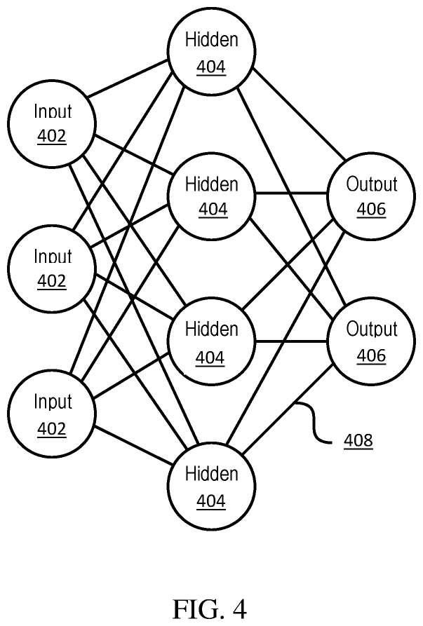

Referring now to FIG. 4, a generalized diagram of a neural network is shown. Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 402 that provide information to one or more “hidden” neurons 404. Connections 408 between the input neurons 402 and hidden neurons 404 are weighted, and these weighted inputs are then processed by the hidden neurons 404 according to some function in the hidden neurons 404. There can be any number of layers of hidden neurons 404, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 406 accepts and processes weighted input from the last set of hidden neurons 404.

This represents a “feed-forward” computation, where information propagates from input neurons 402 to the output neurons 406. Upon completion of a feed-forward computation, the output is compared to a desired output available from training data. The error relative to the training data is then processed in “backpropagation” computation, where the hidden neurons 404 and input neurons 402 receive information regarding the error propagating backward from the output neurons 406. Once the backward error propagation has been completed, weight updates are performed, with the weighted connections 408 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. The training data can be provided by the data that is stored in the historical training database 19. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight 408 may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. Alternatively, the weights 408 may be implemented as resistive processing units (RPUs), generating a predictable current output when an input voltage is applied in accordance with a settable resistance.

As noted, the system 200 includes a historical database 21 of prior orders and how the deliveries were conducted. The historical database 21 includes data on the content of the original order for a user, the location of the pickup points selected by the user for the initial order, and whether the user made an additional purchase in response to previous attempts to set up temporary shopping facility. The historical database 21 may provide the data for training the neural network as described with reference to FIG. 4. The historical database 21 can be used to train the neural network to categorize the original order and to match the categorized original order to other products that the customer may be interested in at the pickup point for additional purchase. In addition to the additional products being in the same category as the product of the original order, the pickup point may also be considered to determine the type of products to be considered for the temporary shopping facility.

It is noted that the neural network is only one example of the type of artificial intelligence that can be employed by the product matching engine 15. It is noted that any type of machine learning is applicable. Machine learning (ML) employs statistical techniques to give computer systems the ability to “learn” (e.g., progressively improve performance on a specific task) with data, without being explicitly programmed. The machine learning method that can be used to suggestion mitigating steps in response to critical paths can employ decision tree learning, association rule learning, artificial neural networks, deep learning, inductive logic programming, support vector machines, clustering analysis, bayesian networks, reinforcement learning, representation learning, similarity and metric learning, sparse dictionary learning, genetic algorithms, rule-based machine learning, learning classifier systems, and combinations thereof.

In some embodiments, the product matching engine 15 can match the original product, e.g., the first product identified by reference number 25A, to other products, e.g., additional products identified by reference numbers 25C, 25D, 25E, by category, previous order history from the user profiles, and the existence of alternative pickup points, as well as temporary shopping facilities using a machine learning algorithm. The machine learning algorithm can be selected from the group consisting of: Almeida-Pineda recurrent backpropagation, ALOPEX, backpropagation, bootstrap aggregating, CN2 algorithm, constructing skill trees, dehaene-changeux model, diffusion map, dominance-based rough set approach, dynamic time warping, error-driven learning, evolutionary multimodal optimization, expectation-maximization algorithm, fastICA, forward-backward algorithm, geneRec, genetic algorithm for rule set production, growing self-organizing map, HEXQ, hyper basis function network, IDistance, K-nearest neighbors algorithm, kernel methods for vector output, kernel principal component analysis, leabra, Linde-Buzo-Gray algorithm, local outlier factor, logic learning machine, LogitBoost, manifold alignment, minimum redundancy feature selection, mixture of experts, multiple kernel learning, non-negative matrix factorization, online machine learning, out-of-bag error, prefrontal cortex basal ganglia working memory, PVLV, Q-learning, quadratic unconstrained binary optimization, query-level feature, quickprop, radial basis function network, randomized weighted majority algorithm, reinforcement learning, repeated incremental pruning to produce error reduction (RIPPER), Rprop, rule-based machine learning, skill chaining, sparse PCA, state-action-reward-state-action, stochastic gradient descent, structured kNN, T-distributed stochastic neighbor embedding, temporal difference learning, wake-sleep algorithm, weighted majority algorithm (machine learning) and combinations thereof.

It is noted that the above examples of algorithms used for machine learning (ML)/artificial intelligence have been provided for illustrative purposes only.

Referring back to FIG. 2, in some embodiments, the method may continue to block 5, which includes delivering the other products, e.g., 25C, 25D and 25E, that were selected based on the characterization of the type of product the consumer 18 has ordered for potential subsequent order and pickup by the customer 18 at the pickup location for a temporary shopping facility 21a, 21b.

In some embodiments, the system 200 is in communication with autonomous deliver vehicles 35 that deliver product for the merchant 30. The merchant 30 may keep an inventory of products on the autonomous delivery vehicles 35. Alternatively, the merchant 30 may load the delivery vehicles to provide additional products, e.g., the products having reference numbers 25C, 25D, 25E, matching what the product matching engine 15 has selected for delivery to the temporary shopping facilities, e.g., the product matching engine 15 may select additional product in a same category as the original product order, and matching the preferences for a user at the selected pickup point, as derived using artificial intelligence from the data in the historical database 21. Additionally, the merchant 30 may maintain an autonomously run inventory factory that uses servo's and motors to maintain the inventory on the autonomous delivery vehicles 35, and/or drones 37, in a manner that allows for the vehicles to stock temporary shopping facilities 21a, 21b to meet the performance requirements of the product matching engine 15.

In addition to the autonomous delivery vehicles 36, the shopping system 200 can employ swarm drones, or locker stores to create temporary shopping experience, e.g., temporary showing facilities 21a, 21b, around the pickup locations with “additional items” readily available. The shopping system 200 can identify the pickup packages, and will be arranging the additional products, e.g., products 25C, 25D, 25E, around the pickup packages. The system will be arranging the products around the pickup products so that it is visible to the customers.

Referring to FIG. 2, at block 6, the computer implemented method may continue to tracking consumer transit to the pickup location, e.g., pickup location 1 26a and/or pickup location 2 26b. In some embodiments, the dynamic shopping system 200 can identify when a customer 18 will be arriving at the pickup point 21a, 21b, or will be sending autonomous vehicle 36 to arrive. Referring to FIG. 3, the system for dynamic shopping 200 can include a user vehicle location tracker 33, which can include GPS tracking. By tracking the user vehicle, e.g., autonomous vehicle 36, the user's location relative to the pickup points 21a, 21b can be determined. If the customer 18 arrives at the pickup point 21a, 21b, then the customer 18 can pick additional products, e.g., products 25 from the temporary created shopping store. The customer 18 can select additional products, e.g., products 25C, 25D, 25E, available in the temporary created shopping store 21a, 21b. Alternatively, if the autonomous vehicle 36 arrives to pick up the product 25A, then the proposed system will be sending notification to the customer 18 about the availability of additional products, i.e., the presence of the temporary shopping facilities 21a, 21b at the pickup points. The autonomous vehicle 36 can pick the additional products 25C, 25D, 25E from the temporary created shopping location 21a, 21b.

Referring back to FIG. 2, the computer implemented method can continue with sending inventory from temporary shopping facility 21a, 21b to the user 18 prior to reaching the pickup point, wherein from the inventory the user can make a supplemental order at block 7. Referring to FIG. 3, the system 200 for dynamic shopping can include a marketplace interface 31 for the subsequent order 31. The marketplace interface 31 may be a web based order page through which the user 18 can view the additional products that have placed at the temporary shopping facilities 21a, 21b. The web based order page can include a list of products, e.g., products 25C, 25D, 25E, as identified by the product matching engine 15, the location of the products, e.g., the location at the pickup point for the initial product order, and the inventory (number of products) at the pickup point. As noted, the system 200 is in communication with the merchant 30, and the merchant delivery vehicles, e.g., autonomous delivery truck 35 and drones 37. For example, the system 200 includes a manufacturer vehicle location tracker 32. From communication with the merchant 30 and the manufacturer vehicle location trackers 32, as well as the user 18, the inventory at the pickup points can be monitor. In some embodiments, from the web based order page, the user 18 may make additional orders, i.e., a supplemental order of the products having reference number 25C, 25D, 25E, to add to their original order purchase, e.g., product 25A.

Referring to FIG. 2, in some embodiments, the computer implemented method may continue to block 8 by determining if a subsequent order was received from the user 18 at block 7. If the user 18 does not make an additional order, e.g., supplemental order, for additional products 25C, 25D, 25E at the temporary shopping facility 21a, 21b of the pickup point 26a, 26b, the method may continue to block 9, which includes providing the product of the initial order, e.g., product 25A, to the user 18, or the user's agent, e.g., user's autonomous vehicle 36. This would end the process flow in the event that the user does not make a supplemental order.

In the event the user 18 makes an additional order, i.e., a supplemental order for additional products 25C, 25D, 25E, the method may continue to blocks 10 and 11. At block 10, when an additional order is received, the system 200 may update the historical database 21. Block 10 represents continual learning through a feedback loop. As noted above, the historical database 21 is used to train the neural network for the artificial intelligence 20 that drives the decision rendering process of the product matching engine 15. Therefore, by updating the historical database 21 in response to user supplemental orders results in retraining of the product matching engine 15 with the most recent trends in customer orders. Further, the shopping patterns of additional items presented to a customer through the autonomous delivery vehicles 35 and drone swarm 37 are analyzed to derive sell-through rate. Success rate of presented items is used to update the forecasting algorithm and modify the items presented to customers, either in-person at the pickup point or remotely through an autonomous vehicle.

At bock 11, the computer implemented method may continue to the method may continue with providing the product of the initial order, e.g., product 25A, as well as any subsequent order, e.g., product 25C, 25D, 25E, to the user 18, or the user's agent, e.g., user's autonomous vehicle 36. This would end the process flow when the user 18 makes a supplemental order.

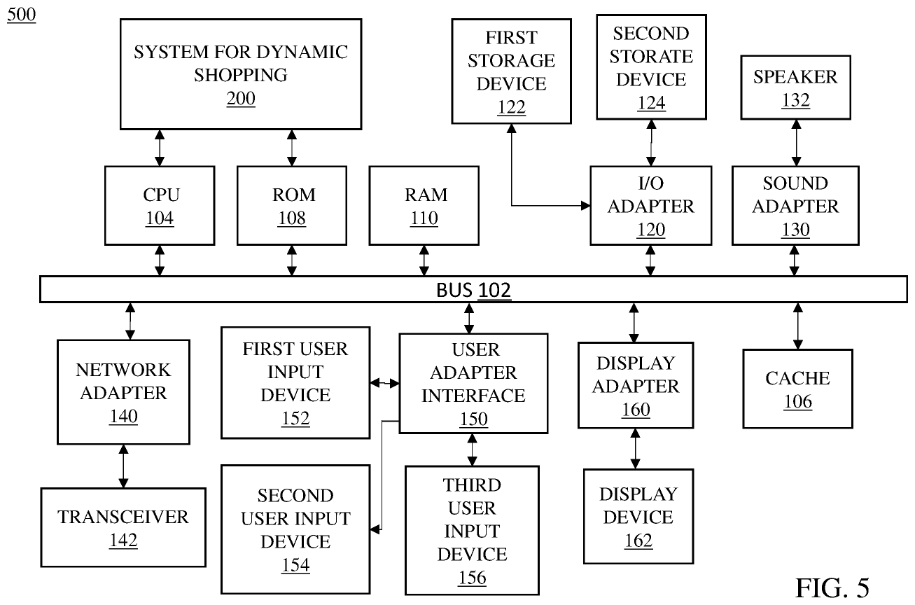

Referring to FIG. 3, in some embodiments, the components of the dynamic shopping system 200 are interconnected by a bus 102. The bus 102 may also be in communication with at least one hardware processor, in which the hardware processor 9 may function with the other elements depicted in FIG. 3 to provide the functions described above. FIG. 5 further illustrates a processing system 500 that can include the customer flexible pickup of dynamic shopping system 200 described with reference to FIGS. 1-3. The exemplary processing system 500 to which the present invention may be applied is shown in accordance with one embodiment. The processing system 500 includes at least one processor (CPU) 104 operatively coupled to other components via a system bus 102. The system bus 102 may be in communication with the system for ranking materials for post combustion carbon capture 200. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102. As illustrated, the system 100 that provides for provenance based identification of policy deviations in cloud environments can be integrated into the processing system 400 by connection to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 400.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present invention provided herein.

The present invention may be a system, a method, and/or a computer program product at any possible technical detail level of integration. For example, in some embodiments, a computer program product is provided for dynamic shopping. The computer program product can include a computer readable storage medium having computer readable program code embodied therewith. The program instructions are executable by a processor. The program instructions are executable by a processor to cause the processor to receive an order for a selected product for purchase by a user and a package pickup location from a device of a user. The computer program product further includes instructions that can cause the processor to determine a type of product the user has ordered for pick up at the package pickup location. Further, using the hardware processor, the program instructions of the computer program product can determine other products which can be displayed to the user at the user device for potential order at the pickup location. The computer program product can also add to the order other products from those displayed to the user at the computer for potential order.

The computer program product may include a computer readable storage medium (or media) having computer readable program instructions thereon for causing a processor to carry out aspects of the present invention. The computer program produce may also be non-transitory.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing.

A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

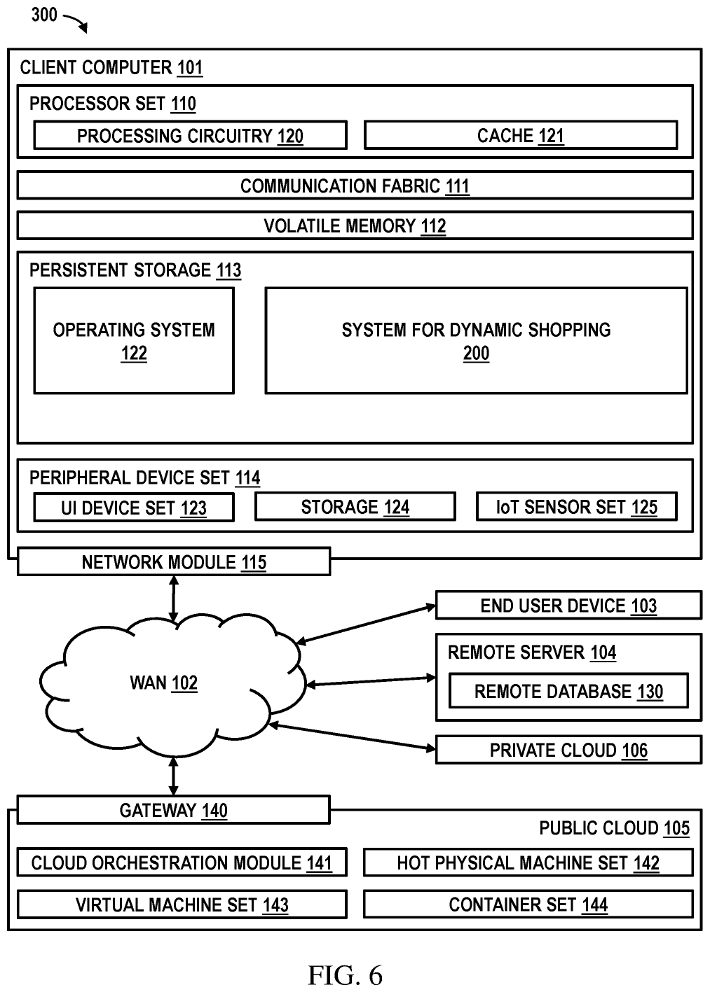

Referring to FIG. 6, the computing environment 300 contains an example of an environment for the execution of at least some of the computer code involved in performing the inventive methods, such as the method for customer flexible pickup of product delivery. In addition to block 200, computing environment 300 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and block 200, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 501, to keep the presentation as simple as possible.

Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 300, at least some of the instructions for performing the inventive methods may be stored in block 200 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 101 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 101 to communicate with other computers through WAN 102. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515. WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments,

EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method for dynamic shopping (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer implemented method for dynamic shopping comprising:
receiving, at a system for dynamic shopping which includes a computer, an order for a selected product and a package pickup location from a device of a user;
determining, at the system for dynamic shopping, a type of product the user has ordered;
determining with a product matching engine of the system for dynamic shopping other products for potential order by the user at the pickup location, wherein the product matching engine employs a neural network trained with a historical database of orders to match the type of the product the user has ordered to categories of products to select the other products for potential order by the user; and
initiating using the system of dynamic shopping, inclusion and transport of the other products with the selected product for delivery to the package pickup location.

2. The computer implemented method of claim 1 further comprising displaying the other products for potential order on the device of the user; and adding to the order for the selected product the other products from those selected by the user from the device of the user.

3. The computer implemented method of claim 1 further comprising tracking a pickup vehicle of the customer during transit to the package pickup location, wherein upon reaching the package pickup location the system for dynamic shopping sends an inventory of the other products to be displayed to the user on the user device for potential order.

4. The computer implemented method of claim 1, wherein the pickup vehicle of the customer is an autonomous vehicle.

5. The computer implemented method of claim 1, wherein the historical database provides training data for the neural network including selected product classification, user profile for selected product classification, pickup locations and temporary shopping facilities at the pickup locations.

6. The computer implemented method of claim 1 further comprising updating the historical database following adding the other products to the order.

7. The computer implemented method of claim 1, wherein the sending of delivery vehicles including the other products to the package pickup location includes autonomous vehicles that stock an inventory at a temporary shopping facility established at the pickup location for the other products.

8. A system for dynamic shopping comprising:
a hardware processor; and
a memory that stores a computer program product, the computer program product when executed by the hardware processor, causes the hardware processor to:
receive an order for a selected product and a package pickup location from a device of a user;
determine a type of product the user has ordered;
determine with a product matching engine products for potential order by the user at the pickup location, wherein the product matching engine employs a neural network trained with a historical database of orders to match the type of the product the user has ordered to categories of products to select the other products for potential order by the user; and
initiate inclusion and transport of the other products with the selected product for delivery to the package pickup location.

9. The system of claim 8, wherein further comprising displaying the other products for potential order on the device of the user; and adding to the order for the selected product the other products from those selected by the user from the device of the user.

10. The system of claim 8 further comprising tracking a pickup vehicle of the customer during transit to the package pickup location, wherein upon reaching the package pickup location the system for dynamic shopping sends an inventory of the other products to be displayed to the user for potential order.

11. The system of claim 8, wherein the pickup vehicle of the customer is an autonomous vehicle.

12. The system of claim 11, wherein the historical database provides training data for the neural network including selected product classification, user profile for selected product classification, and pickup location.

13. The system of claim 12 further comprising updating the historical database following adding the other products to the order.

14. The system of claim 8, wherein the sending of delivery vehicles including the other products to the package pickup location includes autonomous vehicles that stock an inventory at a temporary shopping facility established at the pickup location for the other products.

15. A computer program product for dynamic shopping, the computer program product can include a computer readable storage medium having computer readable program code embodied therewith, the program instructions executable by a processor to cause the processor to:
receive, using the processor, an order for a selected product and a package pickup location from a device of a user;
determine, using the processor, a type of product the user has ordered;
determine, using the processor and a product matching engine, other products for potential order by the user at the pickup location, wherein the product matching engine employs a neural network trained with a historical database of orders to match the type of the product the user has ordered to categories of products to select the other products for potential order by the user; and
initiate, using the processor, inclusion and transport of the other products with the selected product for delivery to the package pickup location.

16. The computer program product of claim 8, wherein further comprising displaying the other products for potential order on the device of the user; and adding to the order for the selected product the other products from those selected by the user from the device of the user.

17. The computer program product of claim 15 further comprising tracking a pickup vehicle of the customer during transit to the package pickup location, wherein upon reaching the package pickup location the system for dynamic shopping sends an inventory of the other products to be displayed to the user for potential order.

18. The computer program product of claim 15, wherein the pickup vehicle of the customer is an autonomous vehicle.

19. The computer program product claim 18, wherein the historical database provides training data for the neural network including selected product classification, user profile for selected product classification, and pickup location.

20. The computer program product of claim 18 further comprising updating the historical database following adding the other products to the order.
